(19) United States
(12) Patent Application Publication
(10) Pub. No.: US 2005/0066157 A1
(43) Pub. Date: Mar. 24, 2005

(54) Process for configuring a computer

(76) Inventor: Kurt Michael Korbatits, Kedron (AU)

Correspondence Address: CANTOR COLBURN LLP, 55 Griffin Road South, Bloomfield, CT, 06002, US

(21) Appl. No.: 10/946,704

(22) Filed: Sep. 22, 2004

(30) Foreign Application Priority Data
Sep. 23, 2003 (AU) 2003248276

(51) Int. Cl. G06F 9/00

(52) U.S. Cl. 713/1

(57) ABSTRACT

A process for reconfiguring a computer at boot up is disclosed. The process involves using an external memory device which contains configuration information and coupling that device to the computer to load the configuration information once sufficient operating system configuration occurs at boot up of the computer.

### BACKGROUND OF THE INVENTION

This invention relates to a process for configuring a computer at boot up.

In particular, the invention relates to a process for configuration of a computer at boot up once enough of a computer operating system has been configured to allow the computer to access an external memory device to configure the computer with user configuration information.

### DESCRIPTION OF PRIOR ART

Computers are usually supplied with an operating system. To ensure that the computer functions as a desired machine such as a workstation, print server, mail server, file server, web server, media player or music player or any other machine configuration, it is necessary to modify base settings of the operating system.

The modification to the base settings are typically carried out by a suitably qualified technician. If a machine with a unique modification from its base settings fails for some reason, the technician must then reconfigure a new machine so that it may function as a suitable replacement for the failed machine. This can be tedious and relatively complex.

### SUMMARY OF THE INVENTION

It is an object of the present invention to provide a process for configuration of a computer at boot up which at least minimises the disadvantages referred to above.

According to one aspect, the invention provides a process for configuring a pre-installed operating system of a computer at boot up whereby configuration information contained in an external memory device is read by the computer once sufficient configuration of the computer has occurred after the commencement of boot-up and the configuration information is used to re-configure the operating system to allow the computer to be configured for a chosen operation.

References in this specification to “configuring a pre-installed operating system of a computer” are to be interpreted as excluding from their scope the configuration of a pre-installed operating system of a computer by upgrading the operating system with a new operating system.

Preferably, the external memory device is a non-volatile memory device although this is not essential. The memory device may be an eprom, eeprom or USB memory device.

The memory device may be coupled to the computer in any suitable way. For example, the memory device may be connected to the computer via a parallel port, serial port, USB port or any other suitable connection such as an infra red port, wireless connection or fire wire interface.

The information contained by the memory device may allow the computer to be configured from its base configuration so that it may function as any one of a plurality of workstations on a network, as a file server, mail server, print server, web server, media player, music player or any other configuration. In this way a workstation or computer of a network may be readily configured to appear and function as any other computer of the network or as any other desired work station.

The information contained in the memory device may include the host name, IP address, Mask, DNS, gateway address, configuration file name to use and any other suitable information such as network settings.

The benefits of the process of the invention include:

(1) the process allows a generic operating system to be installed or image to be used for all types of applications such as firewalls, mail servers, file servers, web servers, media players, music players and other applications.

(2) the process allows the creation of multifunctional devices with a full set of configuration files to allow them to be used for multiple applications.

(3) the process may be used with remote sites where many computers are distributed over a wide area network (WAN). All computers may be treated as just another black box type device. If one fails it may be replaced by another generic unit, the memory device is coupled to the new unit and the unit is reconfigured for that site at boot up.

### DETAILED DESCRIPTION OF THE PREFERRED EMBODIMENT

A particular example of the process of the invention will now be described with reference to the following which is given by example with reference to a Linux operating system. It should be appreciated that the process of the invention may be used with any operating system such as Windows, UNIX and other operating systems.

### EXAMPLE OF IMPLEMENTATION OF METHOD

### Linux Operating System

To create a firewall for local LAN dialup to ISP.

```
  On boot, the bootloader loads the kernel.
  The “init” program is started.
  Then the rc scripts are run.
    *The rc scripts are where the process of the
    invention is implemented:
      basic driver modules are loaded to be able to
      access the external storage device.
      Configuration information is read from the memory
      device.
      For example, the memory device may be a dongle
      coupled to a parallel port of the computer and be
      able to store a string of 256 characters
      representative of the information required to
      reconfigure the computer.
      The string is stored as follows:
Midget bigpond.net.au
FFW,I192.168.005.001/24,D135.235.141.002,P33251313,Utest,
Amidget1
      When this is read back it is interpreted as
      follows.
      Hostname = Midget
      Domain = bigpond.net.au
      Configuration file to use = FW.ini
      IP Address = 192.168.5.1
      Mask = 255.255.255.0 (24 bits)
      DNS = 135.235.141.2
      ISP phone number = 33251313
      Username = test
      Password = midget1
    * This information is updated in the copy of the
generic FW.ini file
    * FW.ini is copied to system.ini and values read
from dongle are replaced in system.ini
The configuration file is as follows:
;Midget Configuration File
;
[GENERAL]
CONFIG=FW
FTP=no
TELNET=no
TELNET_PORT=23
RLOGIN=no
SHELL=no
RCMD=no
NTP=no
NTP_SERVER=ntp1
SNMP=no
HTTP=no
HTTP_PORT=80
[NETWORK]
ADAPTER=smc9194
ADAPTER_IO=320
ADAPTER_IRQ=9
HOSTNAME=(replaced with midget)
IP=(replaced with 192.168.5.1)
MASK=(replaced with 255.255.255.0)
DHCP=no
DHCP_S=190
DHCP_F=200
DOMAIN=(replaced with bigpond.net.au)
DNS_1=(replaced with 135.235.141.2)
DNS_2=
R1=none
R2=none
DEFAULT=no
GATEWAY=
; Serial port 1 is reserved for console login.
[SERIAL2]
DEVICE=/dev/ttyS1
PORT=0x2f8
IRQ=3
UART=16550A
BAUD=115200
TYPE=PPP
PORT_BOUNCE=0
PHONE=ATDT(replaced with phone number for ISP)
ACCOUNT=(replaced with username for ISP)
PASSWORD=(replaced with password for ISP)
LO_IP=0.0.0.0
REMOTE_IP=1.1.1.1
MASK=255.255.255.255
ROUTE1=add,default,ppp0
ROUTE2=none
;For PPP use ROUTE1=add,default,ppp0
[MASQ]
MASQ=yes
IP_ALLOW=192.168.5.0/24
DEVICE=ppp0
```

This new system.ini file is then read in by the rc script files to establish what drivers to load (eg. network card), what services to start and what configurations to use.
The operating system starts up fully configured and ready to use.

1. A process for configuring a pre-installed operating system of a computer at boot up whereby configuration information contained in an external memory device is read by the computer once sufficient configuration of the computer has occurred after commencement of boot up and the configuration information is used to re-configure the operating system to allow the computer to be configured for a chosen operation.

2. The process of claim 1 wherein the configuration information includes one or more of the following: host name, IP address, mask, DNS, gateway address, configuration file name and network settings.

3. The process of claim 1 or 2 wherein the configuration information includes information on programs to be run and drivers to be loaded onto the computer.

4. The process of claim 1 wherein the external memory device is a non-volatile memory device.

5. The process of claim 2 wherein the external memory device is a non-volatile memory device.

6. The process of claim 3 wherein the external memory device is a non-volatile memory device.

7. The process of claim 1 wherein the external memory device is coupled to the computer by a parallel port, serial port, USB port, firewall interface, wireless connection or infra red port.

8. The process of claim 2 wherein the external memory device is coupled to the computer by a parallel port, serial port, USB port, firewall interface, wireless connection or infra red port.

9. The process of claim 3 wherein the external memory device is coupled to the computer by a parallel port, serial port, USB port, firewall interface, wireless connection or infra red port.

10. The process of claim 4 wherein the external memory device is coupled to the computer by a parallel port, serial port, USB port, firewall interface, wireless connection or infra red port.

11. The process of claim 5 wherein the external memory device is coupled to the computer by a parallel port, serial port, USB port, firewall interface, wireless connection or infra red port.

12. The process of claim 6 wherein the external memory device is coupled to the computer by a parallel port, serial port, USB port, firewall interface, wireless connection or infra red port.
